(19) United States
(12) Patent Application Publication
(10) Pub. No.: US 2026/0116414 A1
(43) Pub. Date: Apr. 30, 2026

(54) VEHICLE CONTROL DEVICE AND METHOD OF CONTROLLING THE SAME

(71) Applicants: HYUNDAI MOTOR COMPANY, Seoul (KR); KIA CORPORATION, Seoul (KR)

(72) Inventors: Hong Gyu LEE, Gyeonggi-do (KR); Su Jin HAN, Gyeonggi-do (KR)

(73) Assignees: HYUNDAI MOTOR COMPANY, Seoul (KR); KIA CORPORATION, Seoul (KR)

(21) Appl. No.: 19/221,368

(22) Filed: May 28, 2025

(30) Foreign Application Priority Data
Oct. 25, 2024 (KR) 10-2024-0147593

(51) Int. Cl. B60W 50/14; B60K 35/28; B60W 30/18

(52) U.S. Cl. CPC B60W 50/14; B60K 35/28; B60W 30/18163; B60K 2360/166; B60K 2360/1868; B60W 2050/146; B60W 2520/10; B60W 2552/30; B60W 2552/53; B60W 2555/60; B60W 2556/40

(57) ABSTRACT

A vehicle control device includes one or more processors and a memory storing one or more programs executed by the processors. The processors designate a start point at any point on a driving lane of a vehicle and designate an end point at any point on a target lane that is a lane change target. The processors designate an intermediate point at a center point between the start point and the end point, designate a first sub-point on a driving lane generated from the start point, and designate a second sub-point on a virtual straight line connecting the first sub-point and the intermediate point. The processors generate a lane change route connecting the start point, the first sub-point, the intermediate point, the second sub-point, and the end point.DRAWINGS

### CROSS-REFERENCE TO RELATED APPLICATION

This application claims priority to and the benefit of Korean Patent Application No. 10-2024-0147593, filed on Oct. 25, 2024, the disclosure of which is incorporated herein by reference in its entirety.

### BACKGROUND

### 1. Field of the Invention

Embodiments relate to a vehicle control device and a method for controlling the same.

### 2. Discussion of Related Art

Autonomous vehicles may continuously monitor the environment around the vehicles using various sensors such as cameras, LiDARs, radars, ultrasonic sensors, or the like, and may recognize road situations, positions of other vehicles, pedestrians, lane lines, and the like, in real time through the sensors.

Autonomous vehicles may use a navigation system or route planning algorithm to analyze current routes and determine whether a lane change is necessary. For example, the lane change may be necessary when a road is about to branch or when a vehicle in front is slowly moving.

Meanwhile, the ride comfort of autonomous vehicles is considered as important as stability. When an occupant feels anxious about the ride comfort while the autonomous vehicle is traveling, there may be cases where the autonomous driving system is not trusted no matter how stable the autonomous vehicle is. Therefore, even in the case of auto lane change (ALC) for changing lanes in the autonomous driving system of the vehicle, it is necessary to develop control technology that satisfies both stability and ride comfort.

### SUMMARY OF THE INVENTION

The present invention is directed to providing a vehicle control device capable of improving ride comfort and stability of a vehicle occupant when changing lanes and a method of controlling the same.

The present invention is also directed to providing a vehicle control device capable of relieving anxiety of a vehicle occupant due to a steering angle change when changing lanes on a curved lane and a method of controlling the same.

According to an aspect of the present invention, there is provided a vehicle control device including one or more processors and a memory storing one or more programs executed by the one or more processors, in which the processor includes a first processing unit configured to designate a start point at any point on a driving lane of a vehicle and designate an end point at any point on a target lane that is a lane change target, a second processing unit configured to designate an intermediate point at a center point between the start point and the end point, a third processing unit configured to designate a first sub-point on the driving lane generated from the start point, a fourth processing unit configured to designate a second sub-point on a virtual straight line connecting the first sub-point and the intermediate point, and a fifth processing unit configured to generate a lane change route connecting the start point, the first sub-point, the intermediate point, the second sub-point, and the end point.

The second processing unit may generate a virtual curve connecting the start point and the end point and designate the intermediate point so that a midpoint of the virtual curve becomes a lane line between the driving lane and the target lane.

The third processing unit may designate the first sub-point on a first virtual tangent line on the driving lane generated from the start point using a speed of the vehicle, a lane curvature, and a distance between the start point and the end point.

The third processing unit may designate a foot of a perpendicular line drawn from the intermediate point to the first virtual tangent line as a first sub-point limit point, and designate the first sub-point between the start point and the first sub-point limit point.

The third processing unit may adjust a position of the first sub-point so that a distance between the first sub-point limit point and the first sub-point is shorter as the speed of the vehicle increases.

The third processing unit may adjust a position of the first sub-point so that a distance between the first sub-point limit point and the first sub-point is longer as the distance between the start point and the end point is shorter.

The third processing unit may adjust a position of the first sub-point so that a distance between the first sub-point limit point and the first sub-point is shorter in proportion to a difference value between a first curvature of the driving lane and a second curvature of the target lane when the first curvature is greater than the second curvature.

The third processing unit may adjust the position of the first sub-point so that the distance between the first sub-point limit point and the first sub-point is longer in proportion to the difference value between the first curvature of the driving lane and the second curvature of the target lane when the first curvature is smaller than the second curvature.

The fourth processing unit may designate the second sub-point at a point where the virtual straight line connecting the first sub-point and the intermediate point intersects a second virtual tangent line on the target lane generated from the end point. The fourth processing unit may be configured to calculate a ratio of a distance between the intermediate point and the second virtual tangent line and a distance between the end point and the second sub-point and adjust a position of the second sub-point to within a preset ratio range when the ratio is outside the preset ratio range.

The first processing unit may designate the end point so as to comply with a speed limit on the driving lane and the target lane. According to another aspect of the present invention, there is provided a method of controlling a vehicle performed by a computing device including one or more processors and a memory storing one or more programs executed by the one or more processors, including, by the processor, designating a start point at any point on a driving lane and designating an end point at any point on a target lane, designating an intermediate point at a center point between the start point and the end point, designating a first sub-point on the driving lane generated from the start point, designating a second sub-point on a virtual straight line connecting the first sub-point and the intermediate point, and generating a lane change route connecting the start point, the first sub-point, the intermediate point, the second sub-point, and the end point.

In designating the intermediate point, a virtual curve connecting the start point and the end point may be generated, and the intermediate point may be designated so that a midpoint of the virtual curve becomes a lane line between the driving lane and the target lane.

In designating the first sub-point, the first sub-point may be designated on a first virtual tangent line on the driving lane generated from the start point using a speed of the vehicle, a lane curvature, and a distance between the start point and the end point.

Designating the first sub-point may include designating a foot of a perpendicular line drawn from the intermediate point to the first virtual tangent line as a first sub-point limit point and designating the first sub-point between the start point and the first sub-point limit point.

Designating the first sub-point may further include adjusting a position of the first sub-point so that a distance between the first sub-point limit point and the first sub-point is shorter as the speed of the vehicle increases.

Designating the first sub-point may further include adjusting a position of the first sub-point so that a distance between the first sub-point limit point and the first sub-point is longer as the distance between the start point and the end point is shorter.

Designating the first sub-point may further include adjusting a position of the first sub-point so that a distance between the first sub-point limit point and the first sub-point is shorter in proportion to a difference value between a first curvature of the driving lane and a second curvature of the target lane when the first curvature is greater than the second curvature.

Designating the first sub-point may further include adjusting the position of the first sub-point so that the distance between the first sub-point limit point and the first sub-point is longer in proportion to the difference value between the first curvature of the driving lane and the second curvature of the target lane when the first curvature is smaller than the second curvature.

Designating the second sub-point may include designating the second sub-point at a point where the virtual straight line connecting the first sub-point and the intermediate point intersects a second virtual tangent line on the target lane generated from the end point.

Designating the second sub-point may further include calculating a ratio of a distance between the intermediate point and the second virtual tangent line and a distance between the end point and the second sub-point.

Designating the second sub-point may further include adjusting a position of the second sub-point to within a preset ratio range when the ratio is outside the preset ratio range.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a vehicle transmitting and receiving data by communicating with another device;

FIG. 2 is a diagram illustrating modules constituting a vehicle according to one embodiment of the present disclosure;

FIG. 3 is a diagram illustrating the operation of a vehicle control device according to the embodiment;

FIG. 4 is a view illustrating a process of generating a lane change route according to the embodiment;

FIGS. 5A to 6B are views illustrating the operation of a third processing unit according to the embodiment; and

FIGS. 7 and 8 are flowcharts illustrating a method of controlling a vehicle according to an embodiment.

### DETAILED DESCRIPTION OF EXEMPLARY EMBODIMENTS

Hereinafter, preferred embodiments of the present invention will be described in detail with reference to the accompanying drawings.

However, the technical idea of the present invention is not limited to the embodiments described herein but may be implemented in various different forms, and within the scope of the technical idea of the present invention, one or more among components in the embodiments may be used by being selectively combined and substituted.

Further, unless specifically defined and described, terms used in the embodiments of the present invention (including technical and scientific terms) may be interpreted as having meanings generally understood by those skilled in the art to which the present invention pertains, and commonly used terms such as terms defined in dictionaries may be interpreted in consideration of the contextual meaning of the related art.

The terms used in the embodiments of the present invention are for the purpose of describing the embodiments only and are not intended to limit the invention.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present invention, terms such as first, second, A, B, (a), (b), etc., may be used.

These terms are only for distinguishing one component from another, and the essence, sequence, or order of the components is not limited by these terms. In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above)” or “under (below),” the description may also include an upward or downward direction relative to another component.

Hereinafter, embodiments will be described in detail with reference to the accompanying drawings, but the same or corresponding components are denoted by the same reference numerals regardless of the drawing numbers, and redundant descriptions thereof will be omitted.

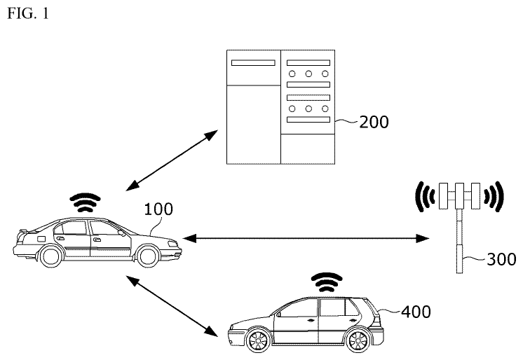

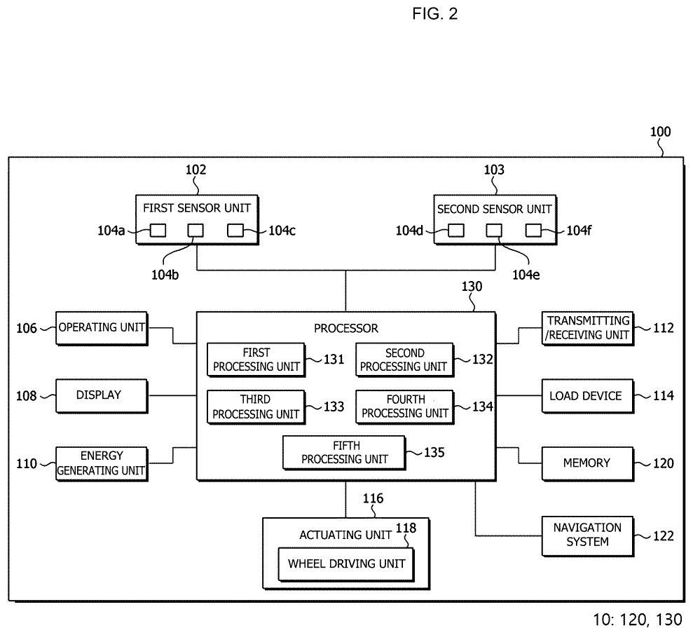

Hereinafter, a vehicle will be described with reference to FIGS. 1 and 2. FIG. 1 is a view illustrating a vehicle transmitting and receiving data by communicating with another device.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas in a liquefied state, for example. Here, the gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 for providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless it contradicts the present disclosure, the present embodiment may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400. The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communication with the server 200, the ITS device 300, and the other vehicle 400. As another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram illustrating modules constituting a vehicle according to one embodiment of the present disclosure.

The vehicle 100 may include sensor units 102 and 103, an operating unit 106, a display 108, a load device 114, and a transmitting/receiving unit 112.

The sensor unit 102 may be provided with various types of detectors to detect various states and situations occurring in an external environment, an internal system, user operation, and a boarding space of the vehicle 100.

Specifically, a first sensor unit 102 may be provided with an externally oriented camera 104a, a lidar sensor 104b, a radar sensor 104c, and the like, to recognize dynamic and static objects present outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor unit is illustrated as having the lidar sensor 104b, but in other examples, the lidar sensor 104b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object. In the present embodiment, external objects may be various objects related to the operation of the vehicle 100.

A second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle traveling information based on sensing data. The vehicle traveling information may be information generated based on data detected by various sensors installed inside the vehicle. For example, the vehicle traveling information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle travel information may include route information. The route information may refer to information generated based on a destination input by a vehicle user through the operating unit 106. The route information may refer to information that indicates a traveling route from a current vehicle position to a destination on a map when the destination has been set. When no destination is set, the route information may refer to information including a road on which a host vehicle is currently traveling and a future driving route including the road.

The operating unit 106 may be configured as a module controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use the autonomous driving function. In order to receive various requests related to autonomous driving, the operating unit 106 may be configured, for example, as a hard-type interface provided at a predetermined position inside the vehicle 100, or as a soft-type interface that can be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting a driver's input for transmitting a driver's request to the processor 130.

The load device 114 is mounted on the vehicle 100 and may be a type of non-driving electrical device excluding a driving power system such as the wheel driving unit 118 or the like. The load device 114 is an auxiliary device that receives electric power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included. The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. According to the embodiment, the navigation unit 122 may be classified as a sub-component of the operating unit 106.

The vehicle control device 10 according to the embodiment may include a memory 120 and the processor 130.

The memory 120 may store applications and various types of data for controlling the vehicle 100 and load applications or read and record data by a request of the processor 130.

The processor 130 may perform overall control of the vehicle 100. The processor 130 may be configured to execute applications and instructions stored in the memory 120.

The processor 130 according to the embodiment may include a first processing unit 131, a second processing unit 132, a third processing unit 133, a fourth processing unit 134, and a fifth processing unit 135.

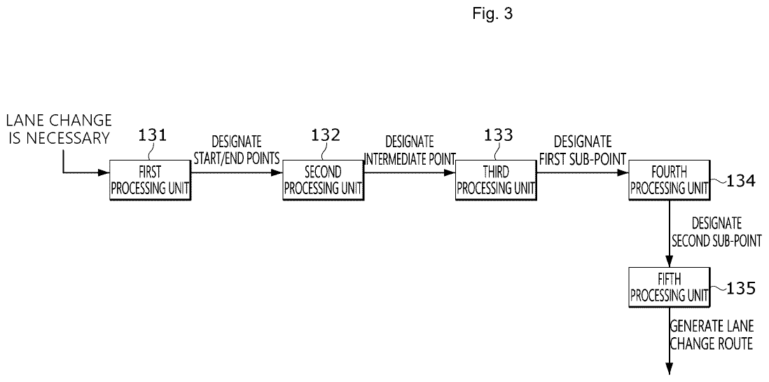

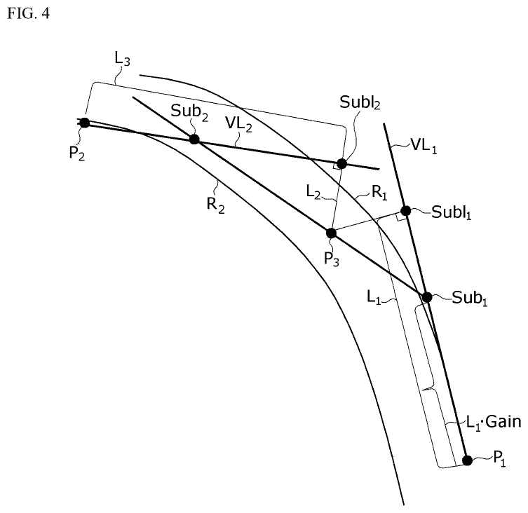

FIG. 3 is a diagram for describing the operation of the vehicle control device according to the embodiment, and FIG. 4 is a view for describing a process of generating a lane change route according to the embodiment. Referring to FIGS. 3 and 4 together, the first processing unit 131 may designate a start point P₁ at any point on a driving lane and designate an end point P₂ at any point on a target lane. In the embodiment, the start point P₁ may refer to a point where a lane change starts on a lane change route for the vehicle requiring the lane change, and the end point P₂ may refer to a point where the lane change ends.

In the embodiment, each point may be defined by two-dimensional coordinates.

In the embodiment, the driving lane may refer to a set of points formed by extending a virtual center line along the lane in which the vehicle is traveling. In addition, the target lane may refer to a set of points formed by extending a virtual center lane on a lane to which the vehicle intends to change.

The first processing unit 131 may determine whether the lane change is necessary according to route information about the vehicle. The first processing unit 131 may determine whether a road is a road on which the lane change is possible using road information, and may determine whether the lane change is possible without causing a collision with an external object or a dangerous situation using external object information detected by the sensor unit.

When it is determined that the lane change is necessary and that the lane change is possible at the same time, the first processing unit 131 may designate the start point P₁ at any point on the route of the lane in which the host vehicle is traveling to establish the lane change route. The start point P₁ may be determined as a current position of the host vehicle or any point on the driving lane of the host vehicle at a future time point relative to the current position of the host vehicle.

In addition, the first processing unit 131 may designate the end point P₂ at any point on the target lane. The first processing unit 131 may determine the target lane, which is the lane change target, using the route information about the vehicle, and designate the end point P₂ using the speed of the host vehicle and road curvature information. For example, the first processing unit 131 may set a distance between the start point P₁ and the end point P₂ to be greater as the speed of the host vehicle increases. In addition, the first processing unit 131 may set the distance between the start point P₁ and the end point P₂ to be greater as the curvature of the road is greater.

In this case, the first processing unit 131 may designate the end point P₂ at a point where the lane change may be completed in a state in which a condition that complies with a speed limit in the corresponding lane is satisfied using navigation information. That is, the first processing unit 131 may designate the end point P₂ to ensure that the lane change may be completed within the limit of not exceeding the speed limit defined in the regulations during an entire period of movement from the start point P₁ to the end point P₂.

The second processing unit 132 may designate an intermediate point P₃ at a center point of the start point P₁ and the end point P₂. The second processing unit 132 may generate a virtual curve connecting the start point P₁ and the end point P₂, and designate an intermediate point P₃ so that a midpoint of the virtual curve becomes a lane line between the driving lane and the target lane.

The second processing unit 132 may form a plurality of virtual curves connecting the start point P₁ and the end point P₂. The virtual curve is formed under the assumption that the vehicle performs a constant velocity motion in a longitudinal direction and a constant acceleration motion in a lateral direction when changing lanes, and may have a shape defined by a quadratic function. The second processing unit 132 may calculate an arc length of the formed virtual curve to derive the midpoint. When the calculated midpoint is positioned on the lane line between the driving lane and the target lane, the second processing unit 132 may designate the corresponding midpoint as the intermediate point P₃.

The intermediate point P₃ is an intermediate start point that serves as a guideline when changing lanes on a curved road, and when the intermediate point P₃ does not exist, it may be impossible or difficult to change lanes on the curved road.

The third processing unit 133 may designate a first sub-point Sub₁ on a first virtual tangent line VL₁ on the driving lane generated from the start point P₁. In the embodiment, the first sub-point Sub₁ may be positioned between the start point P₁ and the intermediate point P₃. The first sub-point Sub1 may serve to restrict the occurrence of an excessively large steering angle at the lane change start point P1.

The first virtual tangent line VL₁ may refer to a virtual straight line extending from the start point P₁ in a direction tangent to the driving lane. The first sub-point Sub₁ may be designated at a specific point on the first virtual tangent line VL₁.

The third processing unit 133 may designate the first sub-point Sub₁ on the first virtual tangent line VL₁ using the speed of the vehicle, the curvature of the lane, and the distance between the start point P₁ and the end point P₂.

For example, the third processing unit 133 may designate the first sub-point Sub₁ at a point on the first virtual tangent line VL₁ that is further from the start point P₁ as the speed of the vehicle increases. In this way, it is possible to prevent a fast vehicle from changing a direction from the start point P₁ to the intermediate point P₃ through sharp steering.

For example, the third processing unit 133 may designate the first sub-point Sub₁ at a point on the first virtual tangent line VL₁ that is closer to the start point P₁ as the distance between the start point P₁ and the end point P₂ of the vehicle is shorter. In the embodiment, the end point P2 may be designated based on the speed of the vehicle. Therefore, the higher the speed of the vehicle, the further the distance between the start point P₁ and the end point P₂ may be set. The third processing unit 133 may designate the first sub-point Sub₁ at a point on the first virtual tangent line VL₁ that is further away from the start point P₁ as the distance between the start point P₁ and the end point P₂ becomes further. In this way, it is possible to prevent a direction change from the intermediate point P₃ to the end point P₂ due to sharp steering.

In addition, the third processing unit 133 may designate the first sub-point Sub₁ based on a difference in curvature between the driving lane and the target lane. When the vehicle intends to change the lane from an inner lane to an outer lane, the lane change is performed from a lane with a relatively large curvature to a lane with a relatively small curvature. In this case, the third processing unit 133 may designate a position of the first sub-point Sub₁ so that the greater the difference in curvature between the two lanes, the further away the first sub-point Sub₁ is from the start point P₁. In this way, it is possible to reduce the centrifugal force applied to a driver of the vehicle.

Alternatively, when the vehicle intends to change the lane from the outer lane to the inner lane, the lane change is performed from a lane with a relatively small curvature to a lane with a relatively large curvature. In this case, the third processing unit 133 may designate the position of the first sub-point Sub₁ so that the greater the difference in curvature between the two lanes, the closer the first sub-point Sub₁ is to the start point P₁. In this way, it is possible to reduce the centrifugal force applied to the driver of the vehicle.

In addition, the third processing unit 133 may first identify a foot of a perpendicular line drawn from the intermediate point P₃ to the first virtual tangent line VL₁ and designate the foot of the perpendicular line as a first sub-point limit point Subl₁. The first sub-point limit point Subl₁ defines a limit range within which the first sub-point Sub₁ may be designated, and the first sub-point Sub₁ may be determined between the start point P₁ and the first sub-point limit point Subl₁.

The third processing unit 133 may set a gain value Gain using the speed of the vehicle, the curvature of the lane, and the distance between the start point P₁ and the end point P₂. The gain value Gain may have a value less than 1. The third processing unit 133 may determine the position of the first sub-point Sub₁ by multiplying a distance L₁ between the start point P₁ and the first sub-point limit point Subl₁ by the gain value Gain.

The third processing unit 133 may adjust the position of the first sub-point Sub₁ so that a distance between the first sub-point limit point Subl₁ and the first sub-point Sub₁ is shorter as the speed of the vehicle increases. The third processing unit 133 may adjust the gain value Gain in proportion to the speed of the vehicle. That is, the third processing unit 133 may adjust the gain value Gain to be larger as the speed of the vehicle increases, and adjust the gain value Gain to be smaller as the speed of the vehicle decreases. In this way, as the speed of the vehicle increases, the first sub-point Sub₁ may be designated as a position closer to the first sub-point limit point Subl₁ and further away from the start point P₁.

In addition, the third processing unit 133 may adjust the position of the first sub-point Sub₁ so that the distance between the first sub-point limit point Subl₁ and the first sub-point Sub₁ is longer as the distance between the start point P₁ and the end point P₂ is shorter. The third processing unit 133 may adjust the gain value Gain in proportion to the distance between the start point P₁ and the end point P₂. That is, the third processing unit 133 may adjust the gain value Gain to be larger as the distance between the start point P₁ and the end point P₂ is longer, and adjust the gain value Gain to be smaller as the distance between the start point P₁ and the end point P₂ is shorter. In this way, as the distance between the start point P₁ and the end point P₂ is longer, the first sub-point Sub₁ may be designated as a position closer to the first sub-point limit point Subl₁ and further away from the start point P₁.

The third processing unit 133 may adjust the position of the first sub-point Sub₁ so that the distance between the first sub-point limit point Subl₁ and the first sub-point Sub₁ is shorter in proportion to the difference value between the first curvature and the second curvature when the first curvature of the driving lane is greater than the second curvature of the target lane. That is, when changing the lane from a lane with a relatively large curvature to a lane with a relatively small curvature, the third processing unit 133 may adjust the gain value Gain to be larger as the difference in curvature is greater, and adjust the gain value Gain to be smaller as the difference in curvature is smaller. In this way, when a vehicle changes from the inner lane to the outer lane, as the curvature difference becomes greater, the first sub-point Sub1 may be designated at a position closer to the first sub-point limit point Subl1 and farther from the start point P1.

The third processing unit 133 may adjust the position of the first sub-point Sub₁ so that the distance between the first sub-point limit point Subl₁ and the first sub-point Sub₁ is longer in proportion to the difference value between the first curvature and the second curvature when the first curvature of the driving lane is smaller than the second curvature of the target lane. That is, when changing the lane from a lane with a relatively small curvature to a lane with a relatively large curvature, the third processing unit 133 may adjust the gain value Gain to be smaller as the difference in curvature is greater, and adjust the gain value Gain to be greater as the difference in curvature is smaller. In this way, when the vehicle changes the lane from the outer lane to the inner lane, as the difference in curvature is greater, the first sub-point Sub₁ may be designated as a position closer to the start point P₁ and further away from the first sub-point limit point Subl₁.

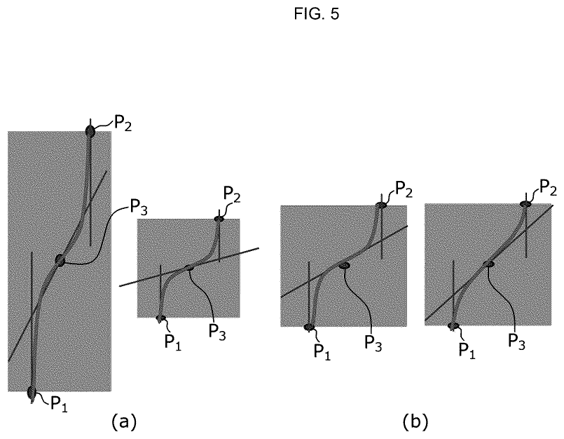

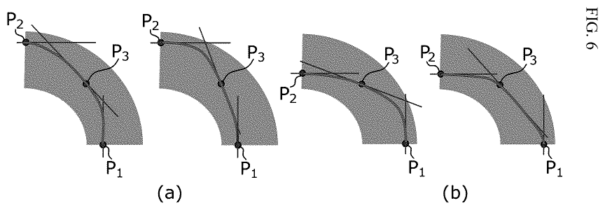

FIGS. 5A to 6B are views for describing the operation of the third processing unit according to the embodiment.

Referring to FIG. 5A together, when the position of the first sub-point Sub₁ is designated using the same gain value Gain, it may be confirmed that, when the gain value Gain calculated on a left route where the speed is relatively high and the distance between the start point P₁ and the end point P₂ is relatively long is applied to a right route to designate the first sub-point Sub₁, a sudden steering change situation occurs. The sudden steering change may not only reduce the ride comfort of an occupant, but may also increase anxiety.

Referring to FIG. 5B together, the third processing unit 133 may prevent the sudden steering change from occurring by adjusting the gain value Gain to a small value when the speed of the vehicle speed is relatively low and the distance between the start point P₁ and the end point P₂ is relatively short.

Referring to FIG. 6A together, when changing lanes from an inner lane with a relatively large curvature to an outer lane with a relatively small curvature, the third processing unit 133 may prevent the sudden steering change from occurring by adjusting the gain value Gain in proportion to the difference in curvature.

Referring to FIG. 6B together, when changing lanes from an outer lane with a relatively small curvature to an inner lane with a relatively large curvature, the third processing unit 133 may prevent the sudden steering change from occurring by adjusting the gain value Gain in inverse proportion to the difference in curvature.

The fourth processing unit 134 may designate a second sub-point Sub₂ at a point where a virtual straight line connecting the first sub-point Sub₁ and the intermediate point P₃ intersects a second virtual tangent line VL₂ on the target lane generated from the end point P₂. In the embodiment, the second sub-point Sub2 may be positioned between the intermediate point P₃ and the end point P₂. The second sub-point Sub₂ may perform the function of restricting a steering angle from being too large when moving from the intermediate point P₃ to the end point P₂.

The second virtual tangent line VL₂ may refer to a virtual straight line extending from the end point P₂ in a direction of approaching the target lane. The fourth processing unit 134 may extend the virtual straight line connecting the first sub-point Sub₁ and the intermediate point P₃ in a direction toward the end point P₂. The fourth processing unit 134 may designate a point where the extended virtual straight line intersects the second virtual tangent line VL₂ as the second sub-point Sub₂.

The fourth processing unit 134 may calculate a ratio of a distance L₂ between the intermediate point P₃ and the second virtual tangent line VL₂ and a distance L₃ between the end point P₂ and the second sub-point Sub₂. The fourth processing unit 134 may adjust the position of the second sub-point Sub₂ to within a preset ratio range when the ratio is outside the preset ratio range. The fourth processing unit 134 may take a foot Subl₂ of the perpendicular line drawn from the intermediate point P₃ to the second virtual tangent line VL₂ and calculate a distance between the foot Subl₂ of the perpendicular line and the intermediate point P₃ as the first distance L₂. The fourth processing unit 134 may calculate the distance between the end point P₂ and the second sub-point Sub₂ as the second distance L₃.

The fourth processing unit 134 does not adjust the position of the second sub-point Sub₂ when the ratio of the first distance L₂ and the second distance L₃ is within the preset ratio range. However, when the ratio of the first distance L₂ and the second distance L₃ is outside the preset ratio range, the fourth processing unit 134 adjusts the position of the second sub-point Sub₂ so that the ratio of the first distance L₂ and the second distance L₃ is within the preset ratio range. For example, when the ratio exceeds the preset ratio range, the fourth processing unit 134 adjusts the position of the second sub-point Sub2 so that the ratio converges to the maximum value of the range. Alternatively, when the ratio of the first distance L₂ and the second distance L3 is less than the preset ratio range, the fourth processing unit 134 adjusts the position of the second sub-point Sub2 so that the ratio converges to a minimum value of the preset ratio range. In this way, it is possible to prevent the sudden steering angle change from occurring when the vehicle moves from the intermediate point P₃ to the end point P2.

The fifth processing unit 135 may generate a lane change route connecting the start point P₁, the first sub-point Sub₁, the intermediate point P₃, the second sub-point Sub₂, and the end point P₂. The fifth processing unit 135 may generate a vehicle driving route so that the vehicle sequentially moves to the end point P₂ through the start point P₁, the first sub-point Sub₁, the intermediate point P₃, and the second sub-point Sub₂. In addition, the vehicle may also calculate a steering angle, a speed, and the like, of the vehicle appropriate to the generated vehicle driving route.

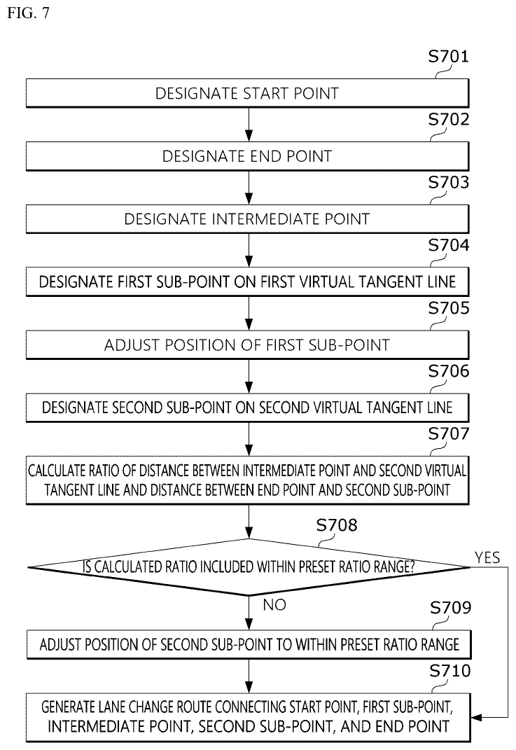

FIG. 7 is a flowchart of a method of controlling a vehicle according to an embodiment. Referring to FIG. 7, the processor designates a start point at any point on a driving lane. The processor designates the start point at any point on a route of a lane in which the host vehicle is traveling. The start point is determined as a current position of the host vehicle or any point on the driving lane of the host vehicle at a future time point relative to the current position of the host vehicle (S701).

Next, the processor designates an end point at any point on a target lane. The processor determines the target lane that is a lane change target using route information about the vehicle, and designates the end point using a speed of the host vehicle, road speed limit information, and road curvature information (S702).

Next, the processor designates an intermediate point at a center point between the start point and the end point. The processor generates a virtual curve connecting the start point and the end point, and designates the intermediate point so that the midpoint of the virtual curve becomes a lane line between the driving lane and the target lane (S703).

Next, the processor designates a first sub-point on a first virtual tangent line on the driving lane generated from the start point (S704).

Next, the processor adjusts a position of the first sub-point using the speed of the vehicle, the curvature of the lane, and a distance between the start point and the end point (S705).

Next, the processor designates a second sub-point at a point where a virtual straight line connecting the first sub-point and the intermediate point intersects a second virtual tangent line on the target lane generated from the end point (S706).

Next, the processor calculates a ratio of a distance between the intermediate point and the second virtual tangent line and a distance between the end point and the second sub-point (S707).

Next, the processor compares the calculated ratio with a preset ratio range (S708).

The processor adjusts a position of the second sub-point to within the preset ratio range when the calculated ratio is outside the preset ratio range (S709).

Next, the processor generates a lane change route connecting the start point, the first sub-point, the intermediate point, the second sub-point, and the end point (S710).

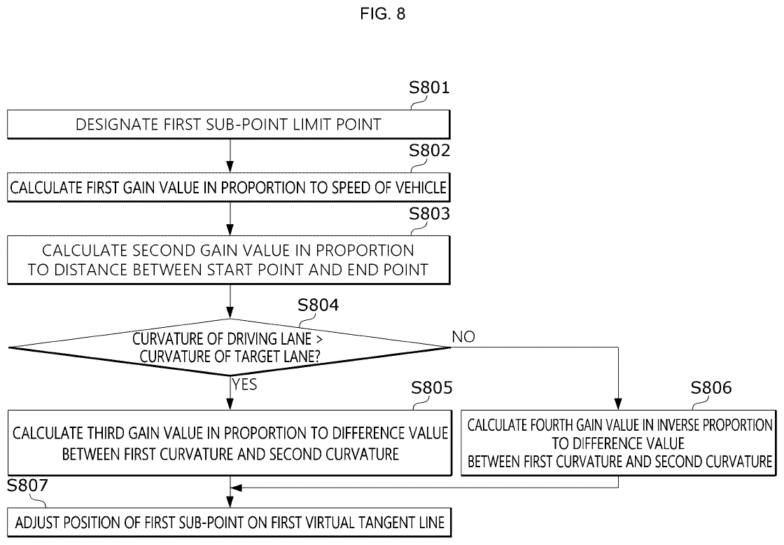

FIG. 8 is a flowchart of the method of controlling a vehicle according to the embodiment. FIG. 8 specifically illustrates the operation of adjusting the first sub-point (S705) in FIG. 7. First, the processor identifies the foot of a perpendicular line drawn from the intermediate point to the first virtual tangent line, and designates it as the first sub-point limit point (S801).

Next, the processor calculates a first gain value that increases in proportion to the speed of the vehicle (S802). In addition, the processor calculates a second gain value having a large value in proportion to the distance between the start point and the end point (S803).

In addition, the processor compares the curvature of the driving lane with the curvature of the target lane (S804).

When a first curvature of the driving lane is greater than a second curvature of the target lane, the processor calculates a third gain value having a large value in proportion to a difference value between the first curvature and the second curvature (S805).

Alternatively, when the first curvature of the driving lane is smaller than the second curvature of the target lane, the processor calculates a fourth gain value having a small value in proportion to the difference value between the first curvature and the second curvature (S806).

Next, the processor adjusts a position of the first sub-point on the first virtual tangent line using a value obtained by multiplying a distance value from the start point to the first sub-point limit point by the first gain value, the second gain value, and the third gain value (or the fourth gain value) (S807).

The term “˜unit” used in the present embodiment refers to software components or hardware components, such as a field-programmable gate array (FPGA) or an application-specific integrated circuit (ASIC), which perform certain functions. However, “˜unit” is not limited to software or hardware. The “˜unit” may be configured to be in an addressable storage medium, or may be configured to reproduce one or more processors. Therefore, for example, “˜unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “˜unit” may be combined into smaller numbers of components and “˜units,” or may be further divided into additional components and “˜units.” Furthermore, the components and “˜units” may be implemented to reproduce one or more CPUs in a device or a security multimedia card.

With a vehicle control device according to an embodiment and a method of controlling the same, it is possible to improve the ride comfort and stability of a vehicle occupant when changing lanes.

In addition, it is possible to relieve anxiety of a vehicle occupant due to a steering angle change when changing lanes in a curved lane.

Although preferred embodiments of the present invention have been described above, it will be understood by those skilled in the art that various changes and modifications may be made without departing from the spirit and scope of the present invention as defined by the claims below.

What is claimed is:

1. A vehicle control device comprising:
a sensor unit;
a display;
one or more processors; and
a memory storing one or more programs executed by the one or more processors,
wherein the sensor unit generates vehicle driving information including path information of a host vehicle based on external input data and sensing data of the host vehicle,
wherein the processor is configured to:
designate a start point at any point on a driving lane of the host vehicle and designate an end point at any point on a target lane that is a lane change target based on the vehicle driving information of the host vehicle and map information stored in the memory;
designate an intermediate point at a center point between the start point and the end point;
designate a first sub-point on the driving lane generated from the start point;
designate a second sub-point on a virtual straight line connecting the first sub-point and the intermediate point; and
generate a lane change route connecting the start point, the first sub-point, the intermediate point, the second sub-point, and the end point and display the lane change route through the display.

2. The vehicle control device of claim 1, wherein the processor generates a virtual curve connecting the start point and the end point and designates the intermediate point so that a midpoint of the virtual curve corresponds to a lane line between the driving lane and the target lane.

3. The vehicle control device of claim 1, wherein the processor designates the first sub-point on a first virtual tangent line on the driving lane generated from the start point based on a speed of the vehicle, a lane curvature, and a distance between the start point and the end point.

4. The vehicle control device of claim 3, wherein the processor designates a foot of a perpendicular line drawn from the intermediate point to the first virtual tangent line as a first sub-point limit point, and designates the first sub-point between the start point and the first sub-point limit point.

5. The vehicle control device of claim 4, wherein the processor adjusts a position of the first sub-point so that a distance between the first sub-point limit point and the first sub-point decreases as the speed of the vehicle increases.

6. The vehicle control device of claim 4, wherein the processor adjusts a position of the first sub-point so that a distance between the first sub-point limit point and the first sub-point increases as the distance between the start point and the end point decreases.

7. The vehicle control device of claim 4, wherein the processor is configured to:
adjust a position of the first sub-point so that a distance between the first sub-point limit point and the first sub-point decreases in proportion to a difference value between a first curvature of the driving lane and a second curvature of the target lane when the first curvature is greater than the second curvature; and
adjust the position of the first sub-point so that the distance between the first sub-point limit point and the first sub-point increases in proportion to the difference value between the first curvature of the driving lane and the second curvature of the target lane when the first curvature is smaller than the second curvature.

8. The vehicle control device of claim 1, wherein the processor designates the second sub-point at a point where the virtual straight line connecting the first sub-point and the intermediate point intersects a second virtual tangent line on the target lane generated from the end point.

9. The vehicle control device of claim 8, wherein the processor is configured to:
calculate a ratio between a distance from the intermediate point to the second virtual tangent line and a distance from the end point to the second sub-point, and
adjust a position of the second sub-point to fall within a preset ratio range when the ratio is outside the preset ratio range.

10. The vehicle control device of claim 9, wherein the processor designates the end point to comply with a speed limit on the driving lane and the target lane.

11. A method of controlling a vehicle performed by a computing device including a sensor unit; a display; one or more processors and a memory storing one or more programs executed by the one or more processors, comprising:
generating, by the sensor unit, vehicle driving information including path information of a host vehicle based on external input data and sensing data of the host vehicle,
designating, by the processor, a start point at any point on a driving lane and designating an end point at any point on a target lane based on the vehicle driving information of the host vehicle and map information stored in the memory;
designating, by the processor, an intermediate point at a center point between the start point and the end point;
designating, by the processor, a first sub-point on the driving lane generated from the start point;
designating, by the processor, a second sub-point on a virtual straight line connecting the first sub-point and the intermediate point;
generating, by the processor, a lane change route connecting the start point, the first sub-point, the intermediate point, the second sub-point, and the end point and displaying, by the processor, the lane change route through the display.

12. The method of claim 11, wherein in the designating of the intermediate point, a virtual curve connecting the start point and the end point is generated and the intermediate point is designated so that a midpoint of the virtual curve corresponds to a lane line between the driving lane and the target lane.

13. The method of claim 11, wherein in the designating of the first sub-point, the first sub-point is designated on a first virtual tangent line on the driving lane generated from the start point based on a speed of the vehicle, a lane curvature, and a distance between the start point and the end point.

14. The method of claim 13, wherein the designating of the first sub-point includes:
designating a foot of a perpendicular line drawn from the intermediate point to the first virtual tangent line as a first sub-point limit point; and
designating the first sub-point between the start point and the first sub-point limit point.

15. The method of claim 14, wherein the designating of the first sub-point further includes adjusting a position of the first sub-point so that a distance between the first sub-point limit point and the first sub-point decreases as the speed of the vehicle increases.

16. The method of claim 14, wherein the designating of the first sub-point further includes adjusting a position of the first sub-point so that a distance between the first sub-point limit point and the first sub-point increases as the distance between the start point and the end point decreases.

17. The method of claim 14, wherein the designating of the first sub-point further includes:
adjusting a position of the first sub-point so that a distance between the first sub-point limit point and the first sub-point decreases in proportion to a difference value between a first curvature of the driving lane and a second curvature of the target lane when the first curvature is greater than the second curvature; and
adjusting the position of the first sub-point so that the distance between the first sub-point limit point and the first sub-point increases in proportion to the difference value between the first curvature of the driving lane and the second curvature of the target lane when the first curvature is smaller than the second curvature.

18. The method of claim 11, wherein the designating of the second sub-point includes designating the second sub-point at a point where the virtual straight line connecting the first sub-point and the intermediate point intersects a second virtual tangent line on the target lane generated from the end point.

19. The method of claim 18, wherein the designating of the second sub-point further includes calculating a ratio between a distance from the intermediate point to the second virtual tangent line and a distance from the end point to the second sub-point.

20. The method of claim 19, wherein the designating of the second sub-point further includes adjusting a position of the second sub-point to fall within a preset ratio range when the ratio is outside the preset ratio range.
